(19) United States
(12) Patent Application Publication
(10) Pub. No.: US 2025/0262603 A1
(43) Pub. Date: Aug. 21, 2025

(54) DRIVE SOCKET CONNECTION

(71) Applicant: Starbucks Corporation, Seattle, WA (US)

(72) Inventors: Joseph E. Gormley, Mercer Island, WA (US); Nathan C. Oren, Edgewood, WA (US)

(21) Appl. No.: 19/041,365

(22) Filed: Jan. 30, 2025

Related U.S. Application Data
(60) Provisional application No. 63/554,544, filed on Feb. 16, 2024.

(51) Int. Cl. B01F 35/31; A47J 43/046; A47J 43/08; B01F 101/00; F16D 1/116

(52) U.S. Cl. CPC B01F 35/31; A47J 43/046; A47J 43/085; F16D 1/116; B01F 2101/1805

(57) ABSTRACT

Generally described, one or more aspects of the present disclosure relate to methods, systems, and devices related to forming a connection assembly for an appliance including a drive socket. The drive socket includes a body having a first aperture at a proximal end, a second aperture at a distal end, and a groove on an exterior surface of the body near the distal end. The connection assembly includes a drive shaft connected to a motor, and a support sleeve including a proximal end configured to receive the drive socket. The support sleeve includes a distal end connected to the drive shaft, and a grab ring positioned on an inner surface of the support sleeve. The grab ring is configured to be positioned within the groove of the drive socket to prevent translation of the drive socket relative to the support sleeve.

### CROSS-REFERENCE TO RELATED APPLICATIONS

The present application claims priority benefit under 35 U.S.C. § 119(e) to U.S. Provisional Patent Application Ser. No. 63/554,544, filed Feb. 16, 2024, titled “DRIVE SOCKET CONNECTION,” the entirety of which is hereby incorporated by reference and should be considered a part of this specification.

### FIELD

The present disclosure relates to systems and methods for a connection of a drive socket to a drive shaft of an appliance or a food processing device, such as a blender.

### DESCRIPTION OF THE CERTAIN RELATED ART

Certain beverages are prepared by use of various appliances, such as a blender. The appliances can have motor with a drive shaft that is mechanically coupled to a shaft of another component of the appliance, such as a blade. The drive sockets can connect to the drive shaft to another component of the appliance. The appliance can include a drive socket that is mechanically connected to the drive shaft of the appliance.

### SUMMARY

The systems, methods and devices of this disclosure each have several innovative aspects, no single one of which is solely responsible for the desirable attributes disclosed herein.

A connection assembly for an appliance is described. The connection assembly can include a drive socket including a body, the body including a first aperture at a proximal end, a second aperture at a distal end, and a groove on an exterior surface of the body near the distal end of the body. The connection assembly can include a drive shaft connected to a motor, and a support sleeve comprising a proximal end configured to receive the drive socket, a distal end connected to the drive shaft, and a grab ring positioned on an inner surface of the support sleeve. The grab ring of the support sleeve can be configured to be positioned within the groove of the drive socket to prevent translation of the drive socket relative to the support sleeve.

In some configurations, the support sleeve comprises a release collar at a proximal end, where the release collar is configured to be gripped by a user to expand a diameter of the proximal end of the support sleeve. In some configurations, the grab ring is configured to be removed from the groove of the drive socket when the release collar expands the diameter of the proximal end of the support sleeve. In some configurations, the groove comprises a concave curvature that extends towards a longitudinal axis of the body. In some configurations, the groove extends around a circumference of a distal portion of the body. In some configurations, the drive shaft is configured to be press fit within the proximal end of the support sleeve in order to enable a transfer of torque between the drive shaft and the support sleeve. In some configurations, the drive shaft is configured to be key fit within the proximal end of the support sleeve in order to enable a transfer of torque between the drive shaft and the support sleeve. In some configurations, the drive shaft and the proximal end of the support sleeve are integral such that torque from the drive shaft is transferred to the support sleeve. In some configurations, the drive shaft is configured to be press fit within the second aperture of the drive socket in order to enable a transfer of torque between the drive shaft and the drive socket. In some configurations, the drive shaft is configured to be key fit within the second aperture of the drive socket in order to enable a transfer of torque between the drive shaft and the support sleeve. In some configurations, the first aperture of the drive socket is configured to receive a drive spline of the appliance. In some configurations, a blender is described. The blender can include a motor housing, a connection assembly as described herein, and a container including a drive spline. The drive spline can engage the first aperture of the connection assembly.

A connection assembly for an appliance is described. The connection assembly can include a drive socket including a body. The body can include a first aperture at a proximal end, a second aperture at a distal end, and a groove on an exterior surface of the body near the distal end of the body. The connection assembly can include a drive shaft connected to a motor, and a support sleeve including a proximal end configured to receive the drive socket, a distal end connected to the drive shaft, and one or more balls positioned on an inner surface of the support sleeve. The one or more balls of the support sleeve can be configured to be positioned within the groove of the drive socket to prevent translation of the drive socket relative to the support sleeve.

In some configurations, the support sleeve includes a stop ring positioned at a distal end of the support sleeve, where the stop ring is configured to prevent the drive socket from moving longitudinally relative to the support sleeve. In some configurations, the support sleeve includes one or more springs extending between the socket body and sidewalls of the support sleeve, where the one or more springs are biased to push the sidewalls of the sleeve longitudinally in a distal direction. In some configurations, the groove includes a concave curvature that extends towards a longitudinal axis of the body. In some configurations, the groove extends around a circumference of a distal portion of the body. In some configurations, drive shaft is configured to be press fit within the proximal end of the support sleeve in order to enable a transfer of torque between the drive shaft and the support sleeve. In some configurations, the drive shaft is configured to be key fit within the proximal end of the support sleeve in order to enable a transfer of torque between the drive shaft and the support sleeve. In some configurations, the drive shaft and the proximal end of the support sleeve are integral such that torque from the drive shaft is transferred to the support sleeve. In some configurations, the drive shaft is configured to be press fit within the second aperture of the drive socket in order to enable a transfer of torque between the drive shaft and the drive socket. In some configurations, the drive shaft is configured to be key fit within the second aperture of the drive socket in order to enable a transfer of torque between the drive shaft and the support sleeve. In some configurations, the first aperture of the drive socket is configured to receive a drive spline of the appliance. In some configurations, a blender is described. The blender can include a motor housing, a connection assembly as described herein, and a container comprising a drive spline, wherein the drive spline engages the first aperture of the connection assembly.

### BRIEF DESCRIPTION OF THE DRAWINGS

Various embodiments are depicted in the accompanying drawings for illustrative purposes and should in no way be interpreted as limiting the scope of the embodiments. Various features of different disclosed embodiments can be combined to form additional embodiments, which are part of this disclosure.

FIG. 1 illustrates an embodiment of a blender.

FIG. 2 illustrates an embodiment of a connection of a drive socket and a drive shaft of a blender in a first configuration.

FIG. 3 illustrates the connection of the drive socket and the drive shaft of the blender of the FIG. 2 in a second configuration.

FIG. 4 illustrates another embodiment of a connection of a drive socket and a drive shaft of a blender in a first configuration.

FIG. 5 illustrates the connection of the drive socket of the drive shaft of the blender of FIG. 4 in a second configuration.

### DETAILED DESCRIPTION

Various beverage preparation systems and methods are described below to illustrate various examples that may achieve one or more desired improvements. These examples are only illustrative and not intended in any way to restrict the general disclosure presented and the various aspects and features of this disclosure. The general principles described herein may be applied to embodiments and applications other than those discussed herein without departing from the spirit and scope of the disclosure. Indeed, this disclosure is not limited to the particular embodiments shown, but is instead to be accorded the widest scope consistent with the principles and features that are disclosed or suggested herein. For example, many of the embodiments are described in the context of a blender. However, certain features and aspects of the disclosure may also have utility in other appliances or devices, such as devices to mix, grind, slice, blend, chop, grate or otherwise process. The devices can have a blade or moving component or rotating component that is rotatably driven by a drive shaft of a motor. A drive socket can be used to couple the drive shaft of the motor to the shaft of the blade or moving component.

Drive sockets in blenders are currently consumable parts such that the drive sockets will wear down over the course of use of the appliance. The drive socket will eventually wear such that the blender is no longer usable and will be sent out for service. During service, a service technician or the manufacturer replace or repair the drive socket, which can involve disassembling the appliance to access the drive socket.

Therefore, there is a need for an improved connection of the drive socket to the drive shaft such that the drive socket can be easily accessed, removed, repaired and/or replaced. The improved drive socket connection can eliminate the need for the appliance to be disassembled to repair or replace the drive socket. This would allow the drive socket to be replaced without requiring the appliance to be sent out or without requiring a trained technician to replace the drive socket. The use of this improved connection can improve equipment functionality and reduce time the repair of the device.

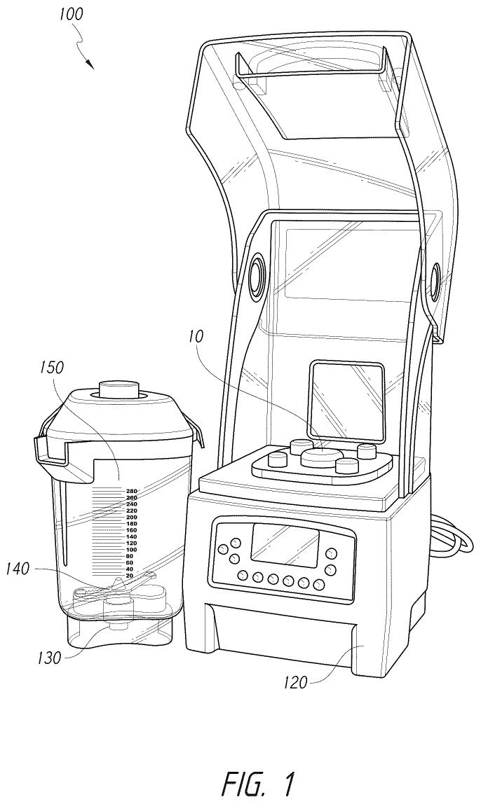

FIG. 1 illustrates a blender 100 including a motor base 120 and a container 150. The motor base 120 includes a drive socket 10. The container 150 includes a blade 140 operably connected to a drive spline 130. The drive spline 130 can include a keyed shape or a spline pattern which can engage with an aperture of the drive socket 10. In a non-limiting example, the keyed shape or spline pattern can be a series of parallel spines or a triangular keyway. The drive spline 130 can be a shaft connected to a blade or another moving component. The container 150 can be placed on the motor base 120 with the drive spline 130 engaging with the drive socket 10. The drive socket 10 can be driven by a motor in the motor base 120. The drive socket 10 can then drive the drive spline 130, which can spin the blade 140. The drive socket 10 can also drive a shaft of a blade or another rotating component. The blade 140 can blend ingredients placed in the container 150. The drive socket 10 can connect to a drive shaft which can be driven by the motor. The drive socket 10 can be attached to a connection assembly as described herein. The connection assembly can be housed within the motor base 120.

Advantageously, the connection assembly can be easily accessible within the motor base 120 without disassembling the motor base 120. In some examples, the drive socket 10 can be replaced and/or repaired without disassembling the motor base 120. The drive socket 10 can be disengaged from the motor base 120 without disassembling the motor base 120. Advantageously, the drive socket 10 can securely engage a drive shaft which is driven by the motor. The drive socket 10 can both effectively transfer torque from the motor to the drive spline 130 and be quickly and simply removed from the motor base 120 for repair and/or replacement.

While the connection assembly described herein is described as being implemented on a blender, it should be understood that the connection assembly can be implemented on another appliance. For example, but not limited to, a food processor, a drill, a mill, a spice grinder, a coffee grinder, a mixer, a rotary sander, or an ice cream maker.

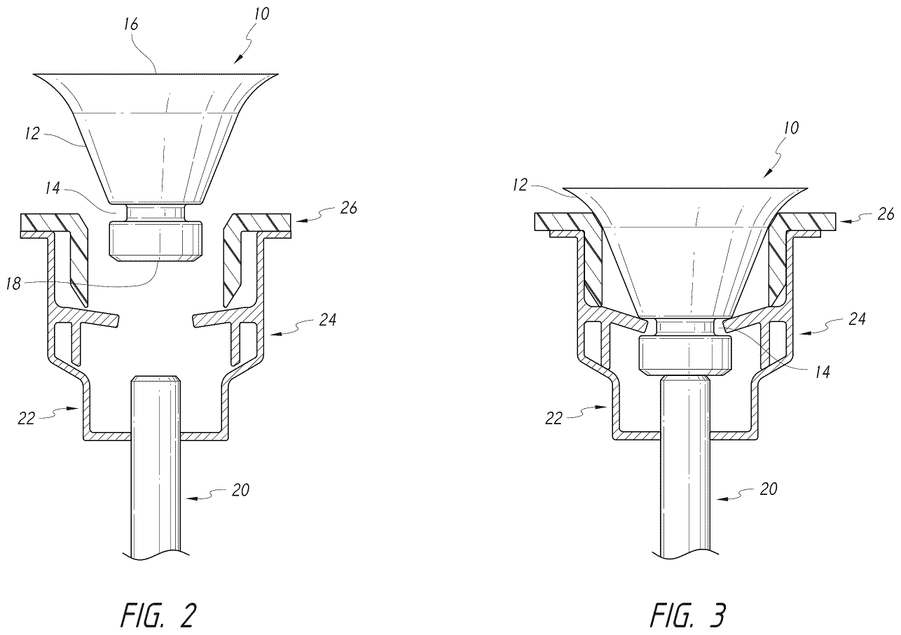

FIG. 2 illustrates an embodiment of a connection assembly of a drive socket and a drive shaft of a blender in a first configuration. FIG. 3 illustrates the connection assembly of the drive socket and the drive shaft of the blender of the FIG. 2 in a second configuration. The connection assembly can provide a releasable connection between the drive socket and the drive shaft.

The drive socket 10 can include a body 12. The body 12 can have a cone shape or be substantially cone shaped. The body 12 of the drive socket 10 has a cone shape such that the diameter of the body 12 changes along the length of the body 12. The body 12 can have a first diameter at a first end or a distal end positioned closer to the drive shaft. The body 12 can also have a second diameter at the second end or a proximal end positioned further away from the drive shaft. The first diameter can be smaller than the second diameter. The first diameter can be the minimum diameter of the body 12. The second diameter can be the maximum diameter of the body 12.

The body 12 can include a groove or lock channel 14. The groove or lock channel 14 can extend partially or entirely around the circumference of the body 12 near the distal end of the body 12. In some examples, the body 12 can include more than one groove or lock channel 14. The groove or lock channel 14 can be a cutout of the body 12 that is positioned along the middle or around a distal portion of the body 12 near the distal end of the body 12. The groove or lock channel 14 can have a concave curvature that extends towards the longitudinal axis of the body 12. The groove or lock channel 14 can be located on an outer circumferential side of the body. The groove or lock channel 14 can be a cutout of the exterior surface of the drive socket 10. The body 12 can also include a first aperture 16 at a proximal end or a first end. The body 12 can include a second aperture 18 at a distal end or a second end.

The first aperture 16 can receive a drive spline or shaft connected to a blade or another moving component (not shown) of the device. The second aperture 18 can receive the drive shaft 20. As shown in FIG. 2, in the first configuration, the drive socket 10 is not connected to the drive shaft 20. As shown in FIG. 3, in the second configuration, the drive socket 10 is connected to the drive shaft 20, such that the drive shaft 20 is received within the second aperture 18 of the drive socket 10. The drive shaft 20 can be connected to or extend from a motor (not shown). The connection of the drive socket 10 and the drive shaft 20 via the second aperture 18 can be connected in a manner that enables a transfer of torque between the drive shaft 20 and the drive socket 10. In some examples, the drive shaft 20 can be press fit into the second aperture 18 of the drive socket 10 such that rotation of the drive shaft 20 rotates the drive socket 10. The press fit connection can enable a transfer of torque from the drive shaft 20 to the drive socket 10. The drive shaft 20 can connect to the second aperture 18 of the drive socket 10 with a size-on-side fit or an interference fit. The second aperture 18 and the drive shaft 20 can have corresponding shapes. The corresponding shapes can engage each other and transfer torque from the drive shaft 20 to the drive socket 10. In some examples, the drive shaft 20 and the second aperture 18 can have a non-round cross-section. In some examples, the drive shaft 20 can have a square cross-sectional profile and the second aperture can have a square cross-sectional profile that receives the square drive shaft. In other examples, the non-round geometry can be triangular or hexagonal, or any other non-round geometry. In some examples, the second aperture 18 can have a series of splines along the inner surface of the second aperture 18 that extend radially. The drive shaft 20 can have a series of protrusions and recesses that correspond to the splines of the second aperture 18. In other examples, the drive shaft 20 can be key fit with the drive second aperture 18 of the drive shaft 20. For example, the drive shaft 20 can include a protrusion that extends perpendicularly from the length of the drive shaft 20 and the drive socket 10 an have a corresponding groove that is configured to receive the protrusion of the drive shaft 20. Similarly, the connection of the first aperture 16 of the drive socket 10 and a drive spline can enable transfer of torque from the drive shaft 20 to the drive spline. As described above, the connection can be press fit or key fit to enable the transfer of torque from the drive shaft 20 to the drive spline and/or a shaft of the blade.

The connection between the drive socket 10 and the drive shaft 20 can include a support sleeve 22. The support sleeve 22 can have a cylindrical body or a cone body. The support sleeve 22 can have a first or distal end and a second or proximal end. The first end of the support sleeve 22 can connect to the drive shaft 20. The drive shaft 20 can be connected to the first end of the support sleeve 22. In some examples, the first end of the support sleeve 22 can define an interior aperture that is sized and configured to receive the drive shaft 20. The drive shaft 20 and the support sleeve 22 can be connected such that torque from the drive shaft 20 is transferred to the support sleeve. Similar to as described above, the connection can be press fit or key fit in order to enable the transfer of torque from the drive shaft 20 to the support sleeve 22. In some examples, the drive shaft 20 can be press fit with the aperture of the first end of the support sleeve 22. In some examples, the drive shaft 20 can be key fit within the aperture of the first end of the support sleeve 22, such that they have a geometric formation that fit together. In some examples, the support sleeve 22 and the drive shaft 20 can be integral such that they are unitary. The support sleeve 22 and the drive shaft 20 can be arranged such that they are configured to rotate together, such that torque from the drive shaft 20 is transferred to the support sleeve 22. The drive socket 10 can be received within the support sleeve 22 such that the second aperture 18 of the drive socket 10 can be positioned over the drive shaft 20.

The support sleeve 22 can further include a grab ring 24 positioned on an inner surface of the support sleeve 22. The grab ring 24 can be positioned in an intermediate or middle section of the support sleeve 22. The interior of the support sleeve 22 can have a step change in diameter. The grab ring 24 can be positioned at the step change of diameter. The inner surface of the support sleeve 22 can not include a step change. In other examples, the inner surface of the support sleeve 22 has a constant inner diameter throughout the length of the support sleeve 22. The grab ring 18 can extend from or be positioned on the inner surface of the support sleeve 22. The second end of the support sleeve 22 can have a release collar 26. The release collar 26 can be configured to allow the second end of the support sleeve 22 to be widened or opened further. In some examples, the release collar 26 can be gripped by a user to expand a diameter of the second end of the support sleeve 22. Expanding the diameter of the second end of the support sleeve 22 widens and opens the second end.

The support sleeve 22 can be configured to receive at least a portion of the drive socket 10. The support sleeve 22 can be configured to receive at least a portion of the distal end of the drive socket 10. In some examples, such as shown in FIG. 3, at least a portion of the distal end of the drive socket 10 can be positioned within the support sleeve 22 such that the lock channel 14 can be positioned entirely within the support sleeve 22. When at least a portion of the drive socket 10 is positioned within the support sleeve 22, the grab ring 24 can be positioned within lock channel 14. The engagement of the grab ring 24 with the lock channel 14 can lock the drive socket 10 to the support sleeve 22. The interaction of the grab ring 24 of the support sleeve 22 and the lock channel 14 of the drive socket 12 can prevent the drive socket 10 from translating or moving longitudinally relative to the support sleeve 22.

When at least a portion of the drive socket 10 is positioned within the support sleeve, such as shown in FIG. 3, the release collar 26 of the support sleeve 22 can be positioned against the body 12 of the drive socket 10. The second diameter of the distal end of the support sleeve 22 can be configured to closely fit against or friction fit with the body 12 of the drive socket 10. The length of the support sleeve 22 can also be configured to position the distal end of the support sleeve 22 at the position relative to the body 12 such that the second diameter corresponds to the diameter of the body 12. The release collar 26 can further support the connection of the support sleeve 22 and the drive socket 10 when the drive socket 10 is at least partially positioned within the support sleeve 22. The release collar 26 can be configured to expand or open to assist in releasing the drive socket 10 from the support sleeve 22. As the release collar 26 is expanded or opened, at least a portion of the sidewalls of the support sleeve 22 and the grab ring 24 are also expanded, such that the grab ring 24 will no longer be fully engaged within the lock channel 14 and the release collar 26 is no longer in contact with the sidewalls of the body 12 of the drive socket 10. In this manner, when the release collar 26 is opened, the drive socket 10 can be pulled out of the support sleeve 22.

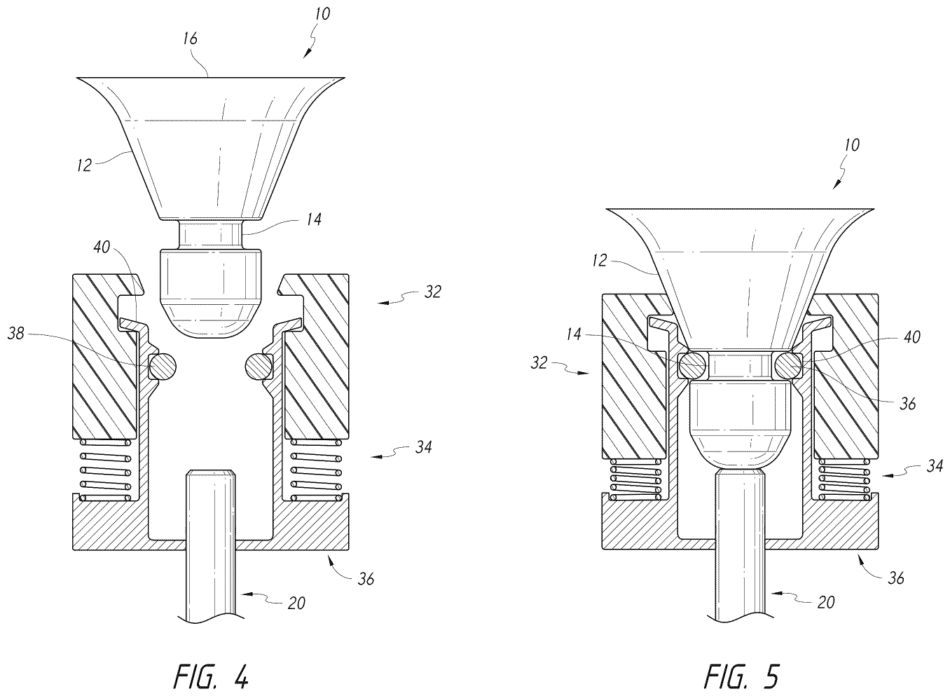

FIG. 4 illustrates another connection assembly of a drive socket and a drive shaft of a blender in a first configuration. FIG. 5 illustrates the connection assembly of the drive socket and the drive shaft of the blender of the FIG. 4 in a second configuration. Some of the features of the connection assembly of FIGS. 4 and 5 are similar to the connection assembly of FIGS. 2 and 3. Thus, reference numerals used to designate the various components of the connection assembly of the FIGS. 2 and 3 are identical to those used for identifying the corresponding components of the connection assembly of FIGS. 4 and 5. Therefore, the structure and description for the various features of the connection assembly in FIGS. 2 and 3 are understood to also apply to the corresponding features of the connection assembly in FIGS. 4 and 5, except as described below.

The connection between the drive socket 10 and the drive shaft 20 can provide a releasable connection between the drive socket 10 and the drive shaft 20. The connection assembly can include a support sleeve 32. The support sleeve 32 can have a cylindrical body or a cone body. The support sleeve 32 can have a first or distal end and a second or proximal end. The first end of the support sleeve 32 can include a socket body 36, which in turn can receive and connect to the drive shaft 20. The support sleeve 32 and the drive shaft 20 can be connected in a manner that enables a transfer of torque between the support sleeve 32 and the drive shaft 20. The drive shaft 20 can be connected to the first end of the support sleeve 22 or to the socket body 36. In some examples, the first end of the support sleeve 22 or the socket body 36 can define an interior aperture that is sized and configured to receive the drive shaft 20. Similar to the connections described above, the drive shaft 20 can be press fit or key fit with the first end of the support sleeve 22 or the socket body 36 to enable a transfer of torque between the drive shaft 20 and the support sleeve 22. The drive shaft 20 can be press fit with the aperture of the first end of the support sleeve 22 or the socket body 36. In some examples, the drive shaft 20 and the aperture of the first end of the support sleeve 22 or the socket body 36 can have a geometric formation that fit together, such as a key fit. For example, the drive shaft 20 and the support sleeve 22 or socket body 36 can have geometries as described above. For example, the drive shaft 20 can include a protrusion that extends perpendicularly from the length of the drive shaft 20 and the support sleeve 22 or the socket body 36 can have a corresponding groove that is configured to receive the protrusion of the drive shaft 20. In some examples, the support sleeve 22 or the socket body 36 can be integral with the drive shaft 20 such that they are unitary. The support sleeve 22 and the drive shaft 20 can be arranged such that they are configured to rotate together, such that torque from the drive shaft 20 is transferred to the support sleeve 22. The socket body 36 can additionally or alternatively define an interior aperture that is sized and configured to receive the drive shaft 20. The drive shaft 20 can be press fit or key fit within the interior aperture of the socket body 36. In this manner, the torque can also be transferred from the drive shaft 20 to the socket body 36 and the support sleeve 32 such that they all rotate together. In some examples, the draft shaft 20 can be unitary with the socket body 36.

The support sleeve 32 can further include a one or more balls 38 positioned on an inner surface of the support sleeve 32. In some examples, the support sleeve 32 can include at least two balls, three balls, or four balls. The one or more balls 38 can be positioned in an intermediate or middle section of the support sleeve 32. The one or more balls 38 can be positioned at the same level or depth of the support sleeve 32. The second end of the support sleeve 22 can have a stop ring 40. The stop ring 40 can have a shape that mirrors the shape of the socket body 36. The stop ring 40 can be configured to prevent the drive socket 10 from translating or moving longitudinally too far relative to the support sleeve 22.

The support sleeve 32 can be configured to receive at least a portion of the drive socket 10. The support sleeve 32 can be configured to receive at least a portion of the distal end of the drive socket 10. In some examples, such as shown in FIG. 5, at least a portion of the distal end of the drive socket 10 can be positioned within the support sleeve such that the lock channel 14 can be positioned entirely within the support sleeve 32. When at least a portion of the drive socket 10 is positioned within the support sleeve 32, the one or more balls 38 can be positioned within lock channel 14. The engagement of the one or more balls 38 with the lock channel 14 can lock the drive socket 10 to the support sleeve 32. The interaction of the one or more balls 38 of the support sleeve 32 and the lock channel 14 of the drive socket 12 can prevent the drive socket 10 from translating or moving longitudinally relative to the support sleeve 32. This locking mechanism requires a secondary operation to release the drive socket 10 from the drive shaft 20. This advantageously secures the drive socket 10 and the drive shaft 20 together.

The support sleeve 32 can further include one or more springs 34 extending between the socket body 36 and the sidewalls of the sleeve 32. The one or more springs 34 can move the sidewalls at the distal ends of the sleeve 32 in a longitudinal direction. The one or more springs 34 can be biased to push the sidewalls of the sleeve 32 longitudinally in a distal direction. In this manner, the one or more springs 34 provides pressure to the sidewalls of the sleeve 32 to push the distal end of the sleeve against the outer surface of the body 12 of the drive socket 10. The springs 34 can act to facilitate the engagement or disengagement of the one or more balls 38 and the lock channel 14. The springs 34 can enable movement of the sidewalls of the sleeve 32 in a longitudinal direction. As the springs 34 compresses or shortens, the sidewalls of the sleeve 32 move longitudinally in a proximal direction, moving closer to the drive shaft 20 and the socket body 36. As the springs 34 expands or lengthens, the sidewalls of the sleeve 32 move longitudinally in a distal direction, moving away from the drive shaft 20 and the socket body 36. A user can apply a force to the sidewalls of the sleeve 32 which in turns applies force on the springs 34 to compress or expand the springs 34. In this manner, the sidewalls of the sleeve 32 can move longitudinally in a proximal or distal direction. The movement of the sidewalls of the sleeve 32 can also move the position of the one or more balls 38 relative to the body of the drive socket 10. When the drive socket 10 is engaged or locked to the drive shaft 20 and sleeve 32, such that the one or more balls 38 are positioned within the lock channel 14, a user can apply pressure to the distal end of the sleeve 32. In response to this applied pressure, the springs 36 can compress and the sidewalls of the sleeve 32 can longitudinally move in a proximal direction. This longitudinal movement of the sleeve 32 can also longitudinally move the one or more balls 38 in a proximal direction. This longitudinal movement of the sidewalls of the sleeve 32 and the one or more balls 38 can occur while the drive socket 10 stays in place. Put another way, the sidewalls of the sleeve 32 and the one or more balls 38 can be moved longitudinally relative to the drive socket 10. This can cause the one or more balls 38 to be disengaged or removed from the lock channel 14 of the drive socket. This can allow separation of the drive socket 10 from the support sleeve 32.

### Certain Terminology

As used herein, the term “beverage” has its ordinary and customary meaning, and includes, among other things, any edible liquid or substantially liquid substance or product having a flowing quality (e.g., juices, coffee beverages, teas, milk, beer, wine, cocktails, liqueurs, spirits, cider, soft drinks, flavored water, energy drinks, soups, broths, combinations of the same, or the like).

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Numbers preceded by a term such as “about” or “approximately” include the recited numbers and should be interpreted based on the circumstances (e.g., as accurate as reasonably possible under the circumstances, for example. For example, “about 1 gram” includes “1 gram.” In the embodiments described in this application, terms such as “about” or “approximately” within the specification or claims that precede values or ranges can be omitted such that this application specifically includes embodiments of the recited values or ranges with the terms “about” or “approximately” omitted from such values and ranges such that they can also be claimed without the terms “about” or “approximately” before the disclosed range. The term “generally” as used herein represents a value, amount, or characteristic that predominantly includes, or tends toward, a particular value, amount, or characteristic. As an example, in certain embodiments, as the context may dictate, the term “generally parallel” can refer to something that departs from exactly parallel by less than or equal to 20 degrees and/or the term “generally perpendicular” can refer to something that departs from exactly perpendicular by less than or equal to 20 degrees.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

The following example embodiments identify some possible permutations of combinations of features disclosed herein, although other permutations of combinations of features are also possible.

### Summary

Although certain aspects, advantages, and features are described herein, it is not necessary that any particular embodiment include or achieve any or all of those aspects, advantages, and features. For example, some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable. In addition, although this disclosure describes certain embodiments and examples of beverage systems and methods, many aspects of the above-described systems and methods may be combined differently and/or modified to form still further embodiments or acceptable examples. All such modifications and variations are intended to be included herein within the scope of this disclosure.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Some embodiments have been described in connection with the accompanying drawings. The figures are drawn to scale, but such scale should not be interpreted to be limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of beverage dispensing systems and methods have been disclosed. Although the systems and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above but should be determined only by a fair reading of the claims that follow as well as their full scope of equivalents.

What is claimed is:

1. A connection assembly for an appliance comprising:
a drive socket comprising a body, the body comprising a first aperture at a proximal end, a second aperture at a distal end, and a groove on an exterior surface of the body near the distal end of the body;
a drive shaft connected to a motor; and
a support sleeve comprising a proximal end configured to receive the drive socket, a distal end connected to the drive shaft, and a grab ring positioned on an inner surface of the support sleeve,
wherein the grab ring of the support sleeve is configured to be positioned within the groove of the drive socket to prevent translation of the drive socket relative to the support sleeve.

2. The connection assembly of claim 1, wherein the support sleeve comprises a release collar at a proximal end, wherein the release collar is configured to be gripped by a user to expand a diameter of the proximal end of the support sleeve.

3. The connection assembly of claim 2, wherein the grab ring is configured to be removed from the groove of the drive socket when the release collar expands the diameter of the proximal end of the support sleeve.

4. The connection assembly of claim 1, wherein the drive shaft is configured to be press fit within the proximal end of the support sleeve in order to enable a transfer of torque between the drive shaft and the support sleeve.

5. The connection assembly of claim 1, wherein the drive shaft is configured to be key fit within the proximal end of the support sleeve in order to enable a transfer of torque between the drive shaft and the support sleeve.

6. The connection assembly of claim 1, wherein the drive shaft and the proximal end of the support sleeve are integral such that torque from the drive shaft is transferred to the support sleeve.

7. The connection assembly of claim 1, wherein the drive shaft is configured to be press fit within the second aperture of the drive socket in order to enable a transfer of torque between the drive shaft and the drive socket.

8. The connection assembly of claim 1, wherein the drive shaft is configured to be key fit within the second aperture of the drive socket in order to enable a transfer of torque between the drive shaft and the support sleeve.

9. The connection assembly of claim 1, wherein the first aperture of the drive socket is configured to receive the appliance.

10. A blender comprising:
a motor housing;
the connection assembly of claim 1; and
a container comprising a drive spline, wherein the drive spline engages the first aperture of the connection assembly.

11. A connection assembly for an appliance comprising:
a drive socket comprising a body, the body comprising a first aperture at a proximal end, a second aperture at a distal end, and a groove on an exterior surface of the body near the distal end of the body;
a drive shaft connected to a motor; and
a support sleeve comprising a proximal end configured to receive the drive socket, a distal end connected to the drive shaft, and one or more balls positioned on an inner surface of the support sleeve,
wherein the one or more balls of the support sleeve are configured to be positioned within the groove of the drive socket to prevent translation of the drive socket relative to the support sleeve.

12. The connection assembly of claim 11, wherein the support sleeve further comprises a stop ring positioned at a distal end of the support sleeve, wherein the stop ring is configured to prevent the drive socket from moving longitudinally relative to the support sleeve.

13. The connection assembly of claim 11, wherein the support sleeve comprises one or more springs extending between the socket body and sidewalls of the support sleeve, wherein the one or more springs are biased to push the sidewalls of the sleeve longitudinally in a distal direction.

14. The connection assembly of claim 11, wherein the groove comprises a concave curvature that extends towards a longitudinal axis of the body.

15. The connection assembly of claim 11, wherein the groove extends around a circumference of a distal portion of the body.

16. The connection assembly of claim 11, wherein drive shaft is configured to be press fit within the proximal end of the support sleeve in order to enable a transfer of torque between the drive shaft and the support sleeve.

17. The connection assembly of claim 11, wherein the drive shaft is configured to be key fit within the proximal end of the support sleeve in order to enable a transfer of torque between the drive shaft and the support sleeve.

18. The connection assembly of claim 11, wherein the drive shaft is configured to be press fit within the second aperture of the drive socket in order to enable a transfer of torque between the drive shaft and the drive socket.

19. The connection assembly of claim 11, wherein the first aperture of the drive socket is configured to receive the appliance.

20. A blender comprising:
a motor housing;
the connection assembly of claim 11; and
a container comprising a drive spline, wherein the drive spline engages the first aperture of the connection assembly.
